(19) United States
(12) Patent Application Publication
(10) Pub. No.: US 2006/0260282 A1
(43) Pub. Date: Nov. 23, 2006

(54) Detachable mobile rack for dust collector

(75) Inventor: Tien-Yu Peng, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: Oav Equipment & Tools, Inc., Taichung City (TW)

(21) Appl. No.: 11/184,810

(22) Filed: Jul. 20, 2005

(30) Foreign Application Priority Data
May 19, 2005 (TW) 94208156

(51) Int. Cl. B01D 46/00

(52) U.S. Cl. 55/356

(57) ABSTRACT

A mobile rack for a dust collector includes a base frame on which the dust collector is mountable, a support frame detachably fastened to the base frame, and a plurality of wheels detachably mounted on the base frame such that the base frame is movable on a floor. The support frame has a mounting portion connectable to a part of the dust collector that is mounted on the base frame.

### BACKGROUND OF THE INVENTION

1. Field of the Invention

The present invention relates to a mobile dust collector and more particularly, to a detachable mobile rack for the dust collector.

2. Description of the Related Art

A dust collector for use in a factory is adapted to suck in and collect suspensions and powders produced during the manufacturing process or any dust in the factory, keeping the environment of the factory clean and preventing adhesion of pollutants to the products to cause contamination.

When using a dust collector in a factory, the dust collector is set in a fixed place inside the factory, and then air ducts are extended from the dust collector to the desired locations for sucking in pollutants. However, when changing the manufacturing process, the dust collector and/or the air ducts may have to be moved to another place. It takes much time and labor to change the position of the dust collector.

### SUMMARY OF THE INVENTION

The present invention has been accomplished under the circumstances in view. It is one object of the present invention to provide a mobile rack for a dust collector, which is detachably conveniently mounted to a dust collector. To achieve this object of the present invention, the mobile rack for a dust collector comprises a base frame on which the dust collector is mountable, a support frame detachably fastened to the base frame, and a plurality of wheels detachably mounted on the base frame such that the base frame is movable on a floor. The support frame has a mounting portion connectable to a part of the dust collector that is mounted on the base frame.

In a preferred embodiment of the present invention, the mobile rack further comprises a support rod, which is detachably mounted on the base frame and connectable to a part of the dust collector that is mounted on the base frame for firmly securing the dust collector.

In a preferred embodiment of the present invention, the base frame comprises two curved connecting portions into which two sides of the support frame are detachably respectively inserted. In the preferred embodiment, the curved connecting portions each have a recessed retaining portion and the support frame has two retaining blocks respectively protruded from the two sides thereof and respectively forced into engagement with the recessed retaining portions of the curved connecting portions.

### BRIEF DESCRIPTION OF THE DRAWINGS

FIG. 1 is a perspective assembly view of a rack of a preferred embodiment of the present invention on which a dust collector is mounted.

FIG. 2 is an exploded view of FIG. 1.

### DETAILED DESCRIPTION OF THE INVENTION

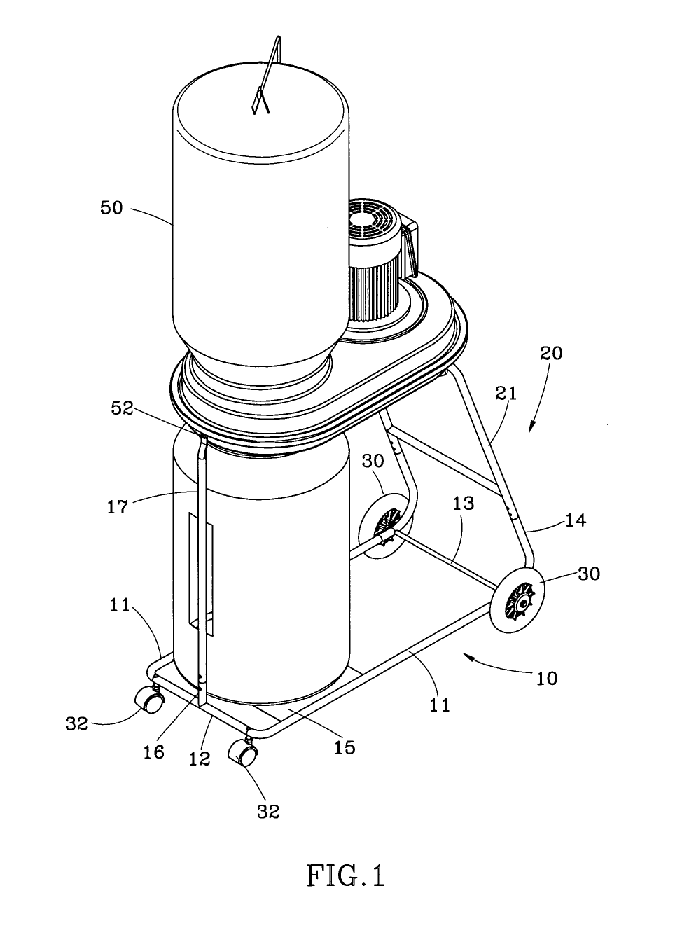

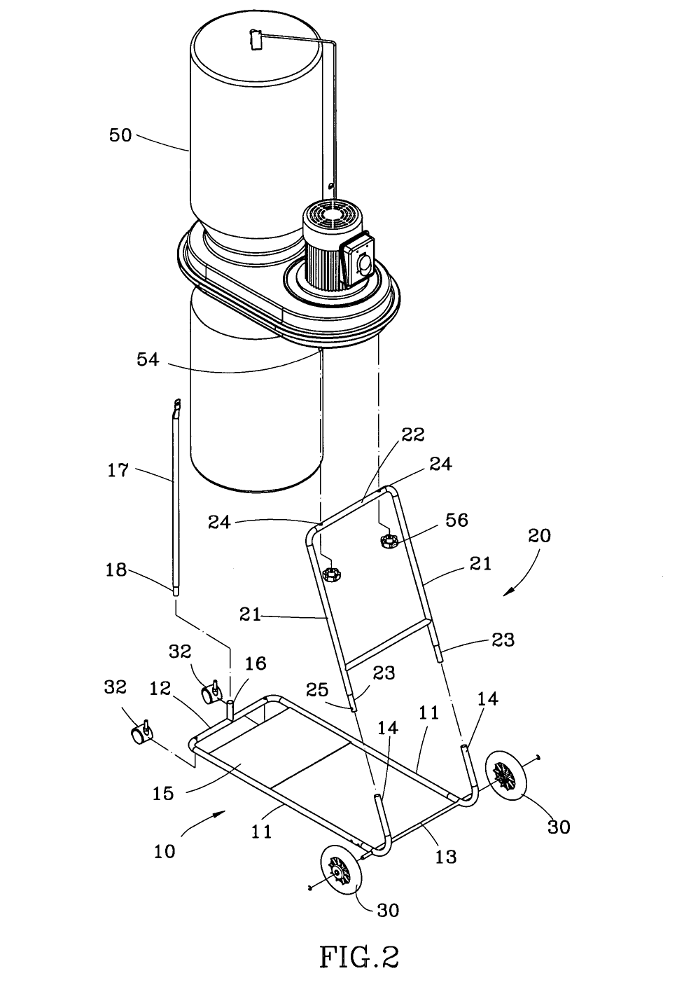

Referring to FIGS. 1 and 2, a mobile rack in accordance with the preferred embodiment of the present invention is shown comprised of a base frame 10, a support frame 20, two wheels 30, and two universal castors 32.

The base frame 10 is integrally formed of metal tubes. The base frame comprises two first sides 11 arranged in parallel, a second side 12 connected between one end, namely, the first end of each of the first sides 11, a wheel axle 13 fastened to and extending across the other end, namely, the second end of each of the first sides 11, and two curved connecting portions 14 respectively extended from the second end of each of the first sides 11. A rectangular bearing plate 15 is connected between the first sides 11. An upright barrel 16 is perpendicularly upwardly extended from the second side 12 on the middle. A support rod 17 has a reduced bottom end 18, which is press-fitted into the barrel 16.

The support frame 20 is integrally formed of metal tubes. The support frame comprises two parallel side frame portions 21, a mounting portion 22 connected between the top ends of the side frame portions 21, two through holes 24 respectively cut through the mounting portion 22, two reduced mounting tips 23 respectively axially extending from the bottom end of each of the two side frame portions 21, and two retaining blocks 25 respectively protruded from the periphery of the reduced mounting tips 23. The two reduced mounting tips 23 of the support frame 20 are respectively inserted into the two curved connecting portions 14 of the base frame 10 to force the retaining blocks 25 into engagement with a respective recessed retaining portion (not shown) in the curved connecting portions 14.

The two wheels 30 are respectively pivotally mounted on the two distal ends of the wheel axle 13. The two universal castors 32 are respectively connected to the two distal ends of the second side 12 of the base frame 10. By means of the wheels 30 and the universal castors 32, the base frame 10 is movable on the floor.

During installation, a dust collector 50 is placed on the bearing plate 15 to have two front bottom screw rods 54 of the dust collector 50 be respectively inserted through the through holes 24 of the mounting portion 22, and then the top end of the supporting rod 17 is fastened to a rear part of the dust collector 50 with a fastener 52, and then two lock nuts 56 are respectively threaded onto the front bottom screw rods 54 of the dust collector 50 and stopped at the bottom side of the mounting portion 22. After installation, the user can push or pull the mobile rack to move the dust collector 50 to a desired place.

When not in use, the support frame 20 can be detached from the base frame 10 to reduce space occupation.

What is claimed is:

1. A mobile rack for a dust collector, said mobile rack comprising:
a base frame on which the dust collector is mountable;
a support frame detachably fastened to said base frame, said support frame having a mounting portion connectable to a part of the dust collector that is mounted on said base frame; and
a plurality of wheels detachably mounted on said base frame such that the base frame is movable on a floor.

2. The mobile rack as claimed in claim 1, further comprising a support rod, which is detachably mounted on said base frame and connectable to a part of the dust collector that is mounted on said base frame.

3. The mobile rack as claimed in claim 1, wherein said base frame comprises two first sides, each of which has a first end and a second end, and a second side connected between the first ends of said first sides; wherein the second ends of said first sides are connected to said support frame.

4. The mobile rack as claimed in claim 1, wherein said base frame comprises two first sides, each of which has a curved connecting portion having a recessed retaining portion, and said support frame comprises two sides respectively inserted into the curved connecting portions, and two retaining blocks respectively protruded from the two sides of said support frame and respectively forced into engagement with the recessed retaining portions in said curved connecting portions.

5. The mobile rack as claimed in claim 1, wherein said mounting portion of said support frame has two through holes for passing respectively through two screw rods; wherein each of the screw rods has an end connected to the dust collector that is mounted on the base frame, and the other end threaded thereto with a lock nut.
